(19) United States
(12) Patent Application Publication
(10) Pub. No.: US 2024/0383267 A1
(43) Pub. Date: Nov. 21, 2024

(54) LIQUID EJECTION DEVICE

(71) Applicant: SEIKO EPSON CORPORATION, Tokyo (JP)

(72) Inventors: Michiru ABE, SHIOJIRI-SHI (JP); Yuki MORIYA, SHIOJIRI-SHI (JP)

(21) Appl. No.: 18/666,136

(22) Filed: May 16, 2024

(30) Foreign Application Priority Data
May 17, 2023 (JP) 2023-081314

(51) Int. Cl. B41J 29/377; B41J 29/02

(52) U.S. Cl. CPC B41J 29/377; B41J 29/023

(57) ABSTRACT

The liquid ejection device 1 includes a carriage 100 whose internal space S is partitioned into a first space S1 and a second space S2 by a partition plate 106, an ejection head 101 that is provided in the first space S1 and that ejects a liquid, and a control substrate 102 that is provided in the second space S2 and that controls a drive of the ejection head 101, wherein the control substrate 102 is connected to the ejection head 101 via a substrate-to-substrate connector 103, and the partition plate 106, as viewed from a direction D in which the control substrate 102 is connected to the ejection head 101, is shaped such that at least one region of region where the control substrate 102 is located, the region where the substrate-to-substrate connector 103 is located, and the region where the ejection head 101 is located, is cut out.

The present application is based on, and claims priority from JP Application Serial Number 2023-081314, filed May 17, 2023, the disclosure of which is hereby incorporated by reference herein in its entirety.

### BACKGROUND

### 1. Technical Field

The present disclosure relates to a liquid ejection device.

### 2. Related Art

Various types of liquid ejection devices have been used. Among these, there is a liquid ejection device including an ejection head for ejecting liquid and a control substrate for controlling drive of the ejection head. For example, JP-A-2013-120861 discloses an inkjet device equipped with a head that ejects ink and a head driver integrated circuit for driving the head, inside a cover of a carriage.

The inkjet device in JP-A-2013-120861 has a large distance between the head and the head driver integrated circuit in the internal space of the carriage. In this configuration where the ejection head and the control substrate are distant far apart, the control responsiveness of the ejection head is reduced. Therefore, it is desirable to make the distance between the ejection head and the control substrate closer in order to increase the control responsiveness of the ejection head. However, the control substrate generates heat when controlling the drive of the ejection head. Therefore, if the distance between the ejection head and the control substrate is made closer, the heat from the control substrate can easily cause the ejection head to heat up. If the ejection head heats up, the landing accuracy of the ejected liquid tends to deteriorate.

### SUMMARY

A liquid ejection device of the present disclosure for solving the above problems, includes a carriage whose internal space is partitioned into a first space and a second space by a partition plate; an ejection head that is provided in the first space and that ejects liquid; and a control substrate that is provided in the second space and that controls drive of the ejection head, wherein the control substrate is connected to the ejection head via a substrate-to-substrate connector and the partition plate, as viewed from a direction in which the control substrate is connected to the ejection head, is shaped such that at least any one region of a region where the control substrate is located, a region where the substrate-to-substrate connector is located, and a region where the ejection head is located, is cut out.

### BRIEF DESCRIPTION OF THE DRAWINGS

FIG. 1 is a schematic side view of a liquid ejection device according to a first embodiment in this disclosure.

FIG. 2 is a perspective view of a carriage of the liquid ejection device in FIG. 1.

FIG. 3 is a perspective view of the carriage of the liquid ejection device in FIG. 1, showing a state in which a carriage cover is removed from the state in FIG. 2.

FIG. 4 is a perspective view of the carriage of the liquid ejection device in FIG. 1, showing a state in which a partition plate is removed from the state in FIG. 3.

FIG. 5 is an enlarged perspective view of a connection section between the ejection head and a control substrate of the carriage of the liquid ejection device in FIG. 1.

FIG. 6 is an enlarged perspective view of the control substrate in a second space of the carriage of the liquid ejection device in FIG. 1, as view from back side.

FIG. 7 is a perspective view of a front side of a carriage of the liquid ejection device according to a second embodiment in this disclosure, showing a state in which a carriage cover is removed.

FIG. 8 is a side view of the carriage of the liquid ejection device according to the second embodiment in this disclosure, showing the state in which the carriage cover is removed.

FIG. 9 is a perspective view of a carriage of the liquid ejection device according to a third embodiment of this disclosure, showing the state in which the carriage cover is removed.

FIG. 10 is a side view of the carriage of the liquid ejection device according to the third embodiment in this disclosure, showing the state in which the carriage cover is removed.

FIG. 11 is a perspective view of a carriage of the liquid ejection device according to a fourth embodiment in this disclosure, showing the state in which the carriage cover is removed.

FIG. 12 is a plan view of the carriage of the liquid ejection device according to the fourth embodiment in this disclosure, showing the state where the carriage cover is removed.

### DESCRIPTION OF EMBODIMENTS

First, a brief description of the present disclosure is described.

A liquid ejection device of a first aspect in this disclosure for solving the above-mentioned problems includes a carriage whose internal space is partitioned into a first space and a second space by a partition plate; an ejection head that is provided in the first space and that ejects liquid; and a control substrate that is provided in the second space and that controls drive of the ejection head, wherein the control substrate is connected to the ejection head via a substrate-to-substrate connector and the partition plate, as viewed from a direction in which the control substrate is connected to the ejection head, is shaped such that at least any one region of a region where the control substrate is located, a region where the substrate-to-substrate connector is located, and a region where the ejection head is located, is cut out.

According to this aspect, the control substrate is connected to the ejection head, which is provided in the first space, via the substrate-to-substrate connector. Therefore, it is possible to shorten the distance between the control substrate and the ejection head by directly connecting the control substrate and the ejection head, and it is possible to increase the control responsiveness of the ejection head. The ejection head, which is provided in the first space, and the control substrate, which is provided in the second space, are partitioned by the partition plate. Further, the partition plate is shaped such that at least any one region of the region where the control substrate is located, the region where the substrate-to-substrate connector is located, and the region where the ejection head is located, is cut out. Therefore, the first space and the second space can be suitably partitioned. By this, it is possible to suitably suppress a temperature rise of the ejection head. Therefore, it is possible to suppress a temperature rise of the ejection head while improving the control responsiveness of the ejection head.

A second aspect of the liquid ejection device in this disclosure is an aspect according to the first aspect above, wherein the partition plate is non metallic.

According to this aspect, the partition plate is non metallic. By making the partition plate non metallic in this way, for example, heat generated in the control substrate can be suitably suppressed from reaching the ejection head, compared to a partition plate made of metal with high thermal conductivity.

A third aspect of the liquid ejection device in this disclosure is an aspect according to the second aspect above, wherein the partition plate is resinous.

According to this aspect, the partition plate is made of resin. Since the resin has particularly low thermal conductivity, it is particularly suitable for suppressing heat generated in the control substrate from reaching the ejection head.

A fourth aspect of the liquid ejection device in this disclosure is an aspect according to any one of the first to third aspects above, wherein the carriage has a fan that generates airflow.

According to this aspect, the carriage has the fan that generates airflow. Therefore, temperature rise inside the carriage can be suitably suppressed, and the heat generated in the control substrate can be particularly suitably suppressed from reaching the ejection head.

A fifth aspect of the liquid ejection device in this disclosure is an aspect according to the fourth aspect above, wherein the liquid ejection device has, as the fan, a first fan that draws air from a space outside the carriage into the internal space.

According to this aspect, the liquid ejection device has the first fan for drawing air from the space outside the carriage into the internal space. Therefore, the first fan can cool the internal space of the carriage by causing air to flow into the internal space from the space outside the carriage.

A sixth aspect of the liquid ejection device in this disclosure is an aspect according to the fifth aspect above, wherein the first fan is provided in the second space.

According to this aspect, the first fan is provided in the second space. Therefore, by cooling the second space, the heat generated in the control substrate can be suppressed from reaching the ejection head.

A seventh aspect of the liquid ejection device in this disclosure is an aspect according to the fourth aspect above, wherein the liquid ejection device has, as the fan, a second fan that exhausts air from the internal space to a space outside the carriage.

According to this aspect, the liquid ejection device has the second fan for exhausting air from the internal space of the carriage to the space outside the carriage. Therefore, the internal space of the carriage can be cooled by the second fan that causes air, which is heated by the heat generated by the control substrate, to flow out from the internal space of the carriage to the space outside the carriage.

An eighth aspect of the liquid ejection device in this disclosure is an aspect according to the seventh aspect above, wherein the second fan is provided in the second space.

According to this aspect, the second fan is provided in the second space. Therefore, the temperature rise of the second space can be suppressed by flowing out the heated air in the second space, and the heat generated in the control substrate can be suppressed from reaching the ejection head.

A ninth aspect of the liquid ejection device in this disclosure is an aspect according to the seventh aspect above, wherein the second fan is provided in the first space.

According to this aspect, the second fan is provided in the first space. Therefore, by moving the air out from the first space before the air in the first space stays there and heat is accumulated and the temperature of the air in the first space rises, the temperature rise of the first space can be suppressed, and the temperature rise of the ejection head can be suppressed.

A tenth aspect of the liquid ejection device in this disclosure is an aspect according to any one of the first to the third aspects above, wherein the liquid ejection device has a plurality of the ejection heads and has a plurality of the control substrates corresponding to each of the ejection heads.

According to this aspect, a control substrate is provided to each of the plurality of the ejection heads. By this configuration, each ejection head can be controlled efficiently.

An eleventh aspect of the liquid ejection device in this disclosure is an aspect according to the tenth aspect above, wherein the second space is partitioned into a third space and a fourth space, and in the third space, a first control substrate as the control substrate, which is connected to a first ejection head among the ejection heads, is provided, and in the fourth space, a second control substrate as the control substrate, which is connected to a second ejection head among the ejection heads, is provided.

According to this aspect, the second space is partitioned into the third space, in which the first control substrate connected to the first ejection head is provided, and the fourth space, in which the second control substrate connected to the second ejection head is provided. Therefore, the heat generated in the first control substrate can be suppressed from reaching the fourth space and the heat generated in the second control substrate can be suppressed from reaching the third space.

### First Embodiment

Hereinafter, embodiments in the present disclosure will be described with reference to the attached figures.

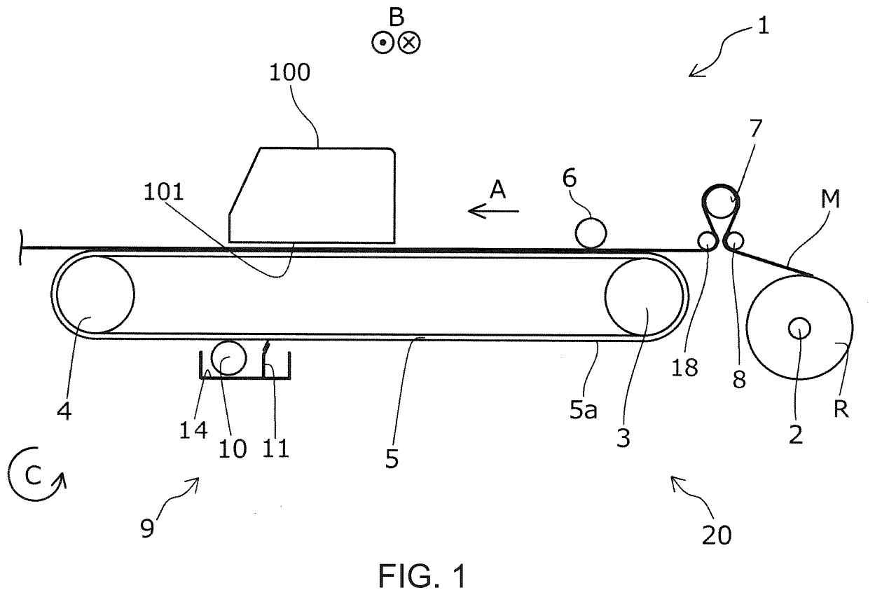

First, an overview of a liquid ejection device 1 in a first embodiment, as the liquid ejection device in this disclosure, will be described mainly with reference to FIG. 1. As shown in FIG. 1, the liquid ejection device 1 of this embodiment is equipped with a transport section 20 that is capable of transporting a medium M in a transport direction A.

The transport section 20 has a feed out section 2 that can feed out a medium M by a roll body R on which the medium M is wound, that is, the medium M in a roll form, being set on it and then by rotating in a rotational direction C. The transport section 20 has a transport belt 5 that can transport the medium M fed from the feed out section 2 in the transport direction A. The transport section 20 has a driven roller 3, which is located on the upstream side of the transport direction A, a drive roller 4, which is located on the downstream side of the transport direction A, and a transport belt 5, which is an endless belt, which is wound over the driven roller 3 and the drive roller 4.

Here, the transport belt 5 is an adhesive belt. The outer surface of the transport belt 5 serves as a support surface for the medium M, and the outer circumferential surface 5a of the transport belt 5 is coated with an adhesive. As shown in FIG. 1, the medium M is transported by being supported by the transport belt 5 in a state in which the medium M is adhered to the outer circumferential surface 5a of the transport belt 5. In the liquid ejection device 1 in this embodiment, a medium support region on which the medium M is supported in the transport belt 5 is the upper side region of the transport belt 5, which is wounded around the driven roller 3 and drive roller 4. The drive roller 4 is a roller that is rotated by a drive force of a motor (not shown), and the driven roller 3 is a roller that is rotated by following the rotation of the transport belt 5, which is caused to rotate by the rotation of the drive roller 4.

The liquid ejection device 1 in this embodiment is equipped with a driven roller 8 and a driven roller 18, which are located between the feed out section 2 and the transport belt 5 in the transport direction A, and which are driven to rotate by the medium M being transported. A brake roller 7 is also equipped between the driven roller 8 and the driven roller 18. The brake roller 7 rotates by the drive force of a motor (not shown) in the same manner as the drive roller 4. The brake roller 7 rotates so that the transport speed at which the medium M is transported by the brake roller 7 is slower than the transport speed of the medium M, which is supported and transported by the transport belt 5, by rotating the brake roller 7 in the rotational direction C. By rotating the brake roller 7 in this manner, tension is applied to the medium M in the transport direction A between the brake roller 7 and the transport belt 5. The medium M is then supported by the transport belt 5 in a state where tension is applied to the medium M in the transport direction A. The liquid ejection device 1 in this embodiment is equipped with a pressure roller 6 that presses the medium M against the transport belt 5 in a region facing the transport belt 5. However, the brake roller 7 and the pressure roller 6 may not be provided.

The liquid ejection device 1 in this embodiment is equipped with a carriage 100, which can reciprocate in a width direction B of the transport belt 5, and heads 101, which are mounted on the carriage 100. The heads 101 are ejection heads that can record images, based on recording data, by ejecting liquid ink onto the medium M that is transported in the transport direction A. Note that the details of an internal structure of the carriage 100 will be described later.

The liquid ejection device 1 in this embodiment can form an image by ejecting ink from the heads 101 onto the medium M being transported, while reciprocating the carriage 100 in the width direction B, which intersects the transport direction A. By equipping the carriage 100 with such a configuration, the liquid ejection device 1 in this embodiment can form a desired image on the medium M by repeatedly transporting the medium M in the transport direction A by a predetermined transport amount and, in a state where the medium M transportation is stopped, ejecting ink while moving the carriage 100 in the width direction B.

As described above, the liquid ejection device 1 in this embodiment is equipped with a so-called serial head type ejection head, in which the heads 101 mounted on the carriage 100 reciprocate in the width direction B. However, it is not limited to such an ejection head. For example, the heads 101 may be a line head type recording section that extends in the width direction B and is fixed in place, and in which are arrayed a plurality of nozzles that eject ink along the width direction B. In the case of a configuration equipped with the line head type recording section, the medium M can be transported in so-called continuous transport, in which the medium M is transported continuously, rather than in so-called intermittent transport, in which the medium M is transported at a predetermined transport amount and is stopped repeatedly, as is the liquid ejection device 1 in this embodiment.

When the medium M on which an image is formed by ejecting ink from the heads 101 is discharged from the liquid ejection device 1 in this embodiment, the medium M is sent to a drying device that volatilizes components of the ink ejected onto the medium M or a winding device that winds up the medium M on which the image is formed. These devices are located at a later stage than the liquid ejection device 1 in this embodiment.

Here, as the medium M, a textile print material can be desirably used. Textile print material refers to fabrics, clothes, other clothing products, and the like that are objects to be printed on. Fabric includes woven, knitted, and non-woven fabrics made of natural fibers such as cotton, silk, and wool, chemical fibers such as nylon, or composite fibers mixed with these fibers. Clothes and other clothing products include sewn T-shirts, handkerchiefs, scarves, towels, carrier bags, bags made of cloth, curtains, sheets, bedspreads, and other furniture, as well as fabric before and after cutting, which exists as parts before being sewn together. However, in addition to the above-mentioned textile print materials, special paper for ink jet printing such as plain paper, high-quality paper, and glossy paper can also be used.

When a textile print material is used as the medium M, the ink ejected onto the textile print material tends to seep through the back side of the medium M, which is a phenomenon of ink bleeding to the back side, and the transport belt 5 may become stained with ink. Thus, the liquid ejection device 1 in this embodiment is equipped with a washing section 9 that washes the ink that bleeds through to the backside of the medium M and adheres to the transport belt 5. The washing section 9 in this embodiment has a storage tank 14 in which washing liquid is stored, a washing roller 10 that is soaked with the washing liquid and that contacts the transport belt 5, and a blade section 11 that wipes off the washing liquid adhering to the transport belt 5.

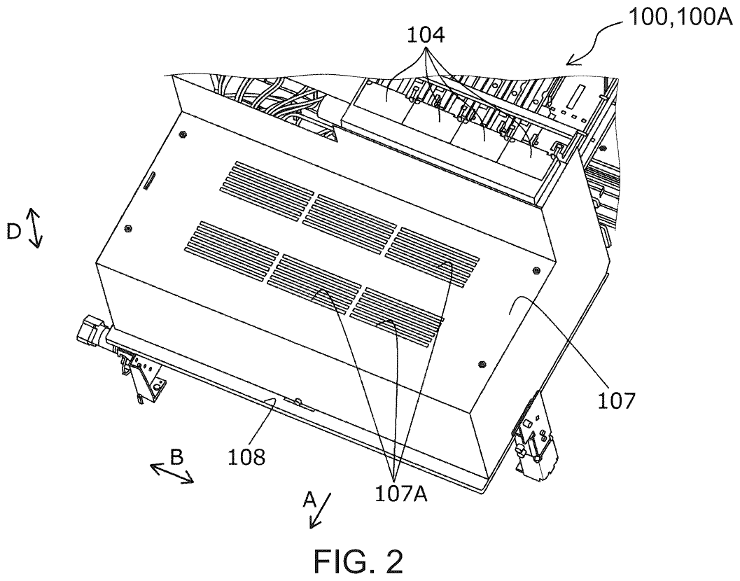

Next, the internal structure of the carriage 100, which is a main part of the liquid ejection device 1 in this embodiment, will be described in detail with reference to FIGS. 2 to 6. Here, the carriage 100 of the liquid ejection device 1 in this embodiment is a carriage 100A shown in FIGS. 2 to 6.

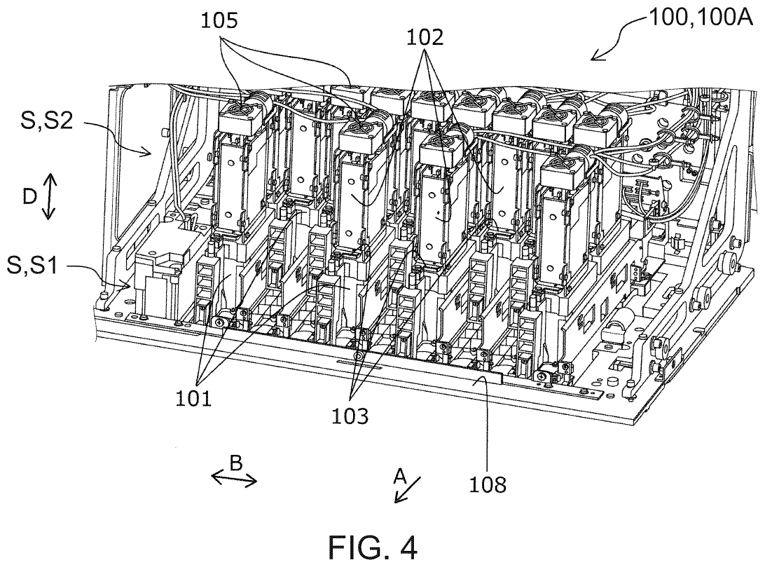

As shown in FIG. 2, the carriage 100A in this embodiment has a cover 107. As shown in FIG. 4, a plurality of the heads 101 are provided inside the cover 107. Each of the heads 101 is attached to a metal plate-shaped member 108 that is made of metal and that is provided in a position facing the transport belt 5. The plate-shaped member 108 shown in FIGS. 2 to 4 also serves as a heat dissipation plate that dissipates heat to outside of the carriage 100A during reciprocation along the width direction B of the carriage 100A.

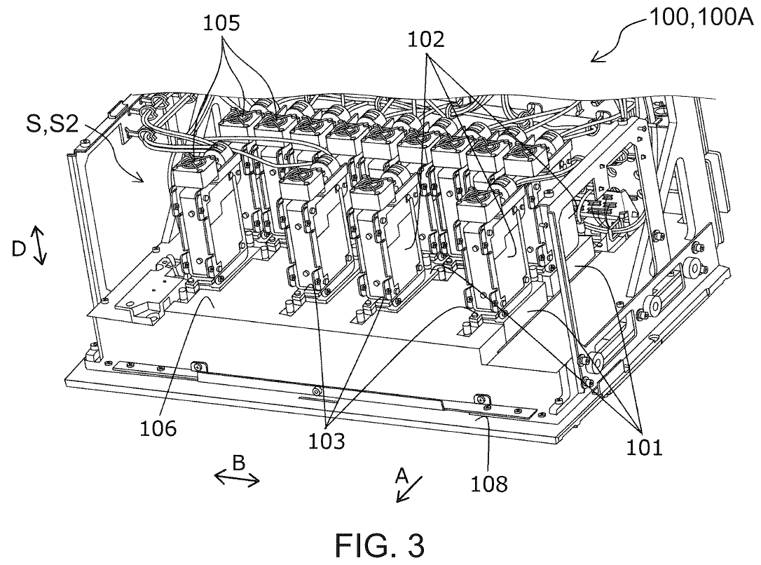

Inside the cover 107, as shown in FIG. 3 and the like, there is one control substrate 102 for each of the heads 101 that controls drive of the heads 101. In other words, the liquid ejection device 1 in this embodiment has a plurality of the heads 101 and a plurality of the control substrates 102 corresponding to respective heads 101. With this configuration, each of the heads 101 can be controlled efficiently.

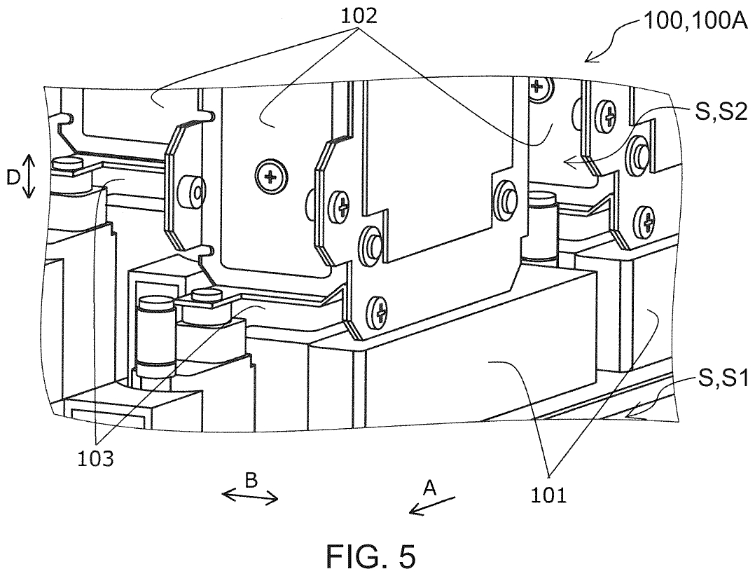

The control substrates 102 in this embodiment are, to be precise, a substantially rectangular parallelepiped structure with a plurality of substrates are formed inside. In this specification, the structure itself in which such substrates are formed is considered to be a control substrate 102. As shown in FIG. 5 and the like, the control substrates 102 are connected to the heads 101 via substrate-to-substrate connectors 103. Further, as shown in FIG. 3 and the like, a partition plate 106 that partitions the internal space S of the carriage 100A into a first space S1 and a second space S2 is provided inside the cover 107.

As described above, the liquid ejection device 1 in this embodiment is equipped with the carriage 100A in which the internal space S is partitioned into the first space S1 and the second space S2 by the partition plate 106. The liquid ejection device 1 in this embodiment is equipped with the heads 101 for ejecting ink and, as shown in FIGS. 3 and 4, the heads 101 are provided in the first space S1. The liquid ejection device 1 in this embodiment is equipped with the control substrates 102 for controlling the drive of the heads 101, and as shown in FIGS. 3 and 4, the control substrates 102 are provided in the second space S2.

As described above, the control substrate 102 are connected to the heads 101 via the substrate-to-substrate connectors 103. In other words, the distance between the control substrates 102 and the heads 101 is shortened by directly connecting the control substrates 102 to the heads 101. Therefore, control responsiveness of the heads 101 can be high in the liquid ejection device 1 in this embodiment.

Here, in the liquid ejection device 1 in this embodiment, the partition plate 106 has a shape in which regions where the heads 101 are located are cut out as viewed from the direction D in which the control substrates 102 connect to the heads 101. As described above, it is desirable that the partition plate 106 has a shape in which at least any one region of the regions where the control substrates 102 are positioned, the regions where the substrate-to-substrate connectors 103 are positioned, and the regions where the heads 101 are positioned is cut out as viewed from the direction D in which the control substrates 102 are connected to the heads 101. By adopting such a shape, the first space S1 where the heads 101 are provided and the second space S2 where the control substrates 102 is provided can be suitably partitioned. Therefore, heat generated in the control substrates 102 can be effectively suppressed from reaching the heads 101, and a rise in temperature of the heads 101 can be suitably suppressed. Therefore, the liquid ejection device 1 in this embodiment can suppress a temperature rise of the heads 101 while improving the control response of the heads 101. Further, by shaping the partition plate 106 so that at least any one region of the regions where the control substrates 102 are located, the regions where the substrate-to-substrate connectors 103 are located, and the regions where the heads 101 are located are cut out, it is easier to replace or maintain the heads 101 or control substrates 102.

In this embodiment of the liquid ejection device 1, the partition plate 106 is composed of a polyethylene sheet. The partition plate 106 is desirably non metallic. The partition plate 106 can be composed of metal. However, by composing the partition plate 106 of a non metallic material as in the liquid ejection device 1 in this embodiment, the heat generated in the control substrates 102 can be suitably suppressed from reaching the heads 101, compared to composing the partition plate 106 of a metal with high thermal conductivity.

In particular, the partition plate 106 is desirably a resinous material, such as plastic or rubber. Since resin has good moldability and has particularly low thermal conductivity, it is possible to particularly suitably suppress heat generated in the control substrates 102 from reaching the heads 101 by composing the partition plate 106 of a resinous material.

As shown in FIG. 2, the liquid ejection device 1 in this embodiment is equipped with four carriage fans 104 that draw air from the space outside the carriage 100A to the internal space S at a position corresponding to an upper portion of the second space S2 of the carriage 100A. As shown in FIGS. 3 and 4, the liquid ejection device 1 in this embodiment is also equipped with individual fans 105 corresponding to each of the plurality of the control substrates 102 at a position corresponding to the second space S2 in the internal space S of the carriage 100A. As described above, it is desirable that the carriage 100A has a fan that generates airflow. By the carriage 100A having a fan that generates airflow, it is possible to suitably suppress a temperature rise inside the carriage 100A and to particularly suitably suppress heat generated in the control substrates 102 from reaching the heads 101.

Here, each of the carriage fans 104 can be described as a first fan that draws air from the space outside the carriage 100A into the internal space S. With this configuration of the carriage having the carriage fans 104, the internal space S of the carriage 100A can be cooled by causing air to flow from the space outside the carriage 100A into the internal space S by the carriage fans 104.

As described above, the carriage fans 104 are provided in the second space S2. With such a configuration, by cooling the second space S2, it is possible to suppress the heat that is generated in the control substrates 102 from reaching the heads 101.

As described above, the liquid ejection device 1 in this embodiment is equipped with the individual fans 105 as the fan. Each individual fan 105 serves as a second fan that exhausts air, which is drawn into the internal space S from the space outside the carriage 100A by the carriage fans 104, from the internal space S of carriage 100A to the space outside the carriage 100A. By the configuration having the second fan that exhausts air from the internal space S of the carriage 100A to the space outside, and by causing air heated by the heat generated in the control substrates 102 to flow out from the internal space S of the carriage 100A to the space outside the carriage 100A by the second fan, the internal space S of the carriage 100A can be cooled.

In the liquid ejection device 1 in this embodiment, as shown in FIGS. 3, 4 and the like, the individual fans 105 are provided in the second space S2. Therefore, the liquid ejection device 1 in this embodiment can suppress the temperature rise in the second space S2 by causing air in the second space S2 that is heated up to flow out, and can suppress the heat generated in the control substrates 102 from reaching the heads 101.

Note that, as shown in FIG. 2, the cover 107 of the carriage 100A has exhaust ports 107A. By this, the liquid ejection device 1 in this embodiment can cause the air that was sucked by the carriage fans 104 from the internal space S to the space outside to, by the individual fans 105, flow from the internal space S of the carriage 100A through the exhaust ports 107A to the space outside.

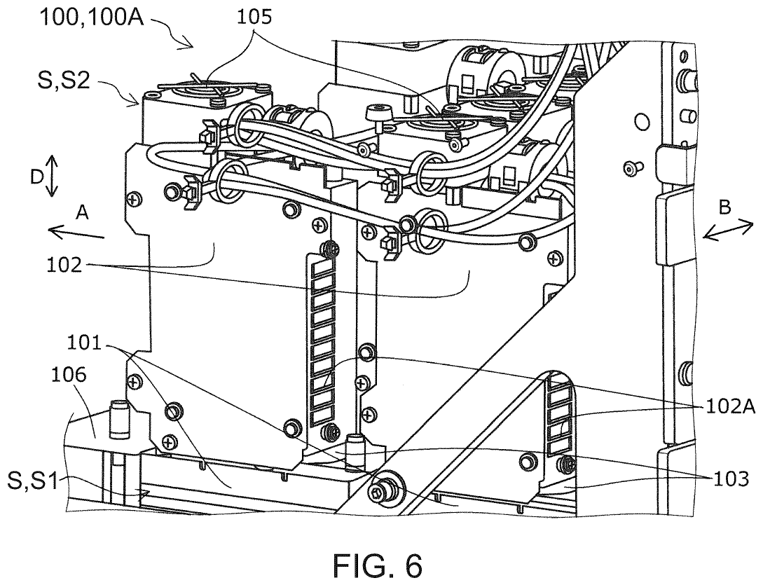

Further, as shown in FIG. 6, the liquid ejection device 1 in this embodiment is equipped with a suction holes 102A on the back side surface of the control substrates 102. The individual fans 105 are located on the upper portion of the control substrates 102. With such a configuration, in the second space S2, air flows into the inside of the control substrates 102 through the suction holes 102A, and the individual fans 105 send the air that flowed inside the control substrates 102 to above the individual fans 105. The air sent above the individual fans 105 flows out from the internal space S of the carriage 100A to the space outside the carriage 100A through the exhaust ports 107A provided in the cover 107. With such a configuration, the control substrates 102 can be effectively cooled.

### Second Embodiment

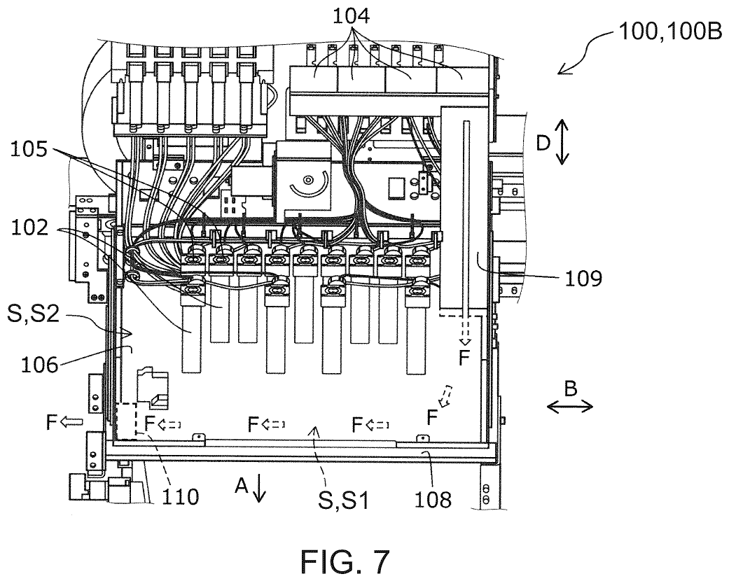

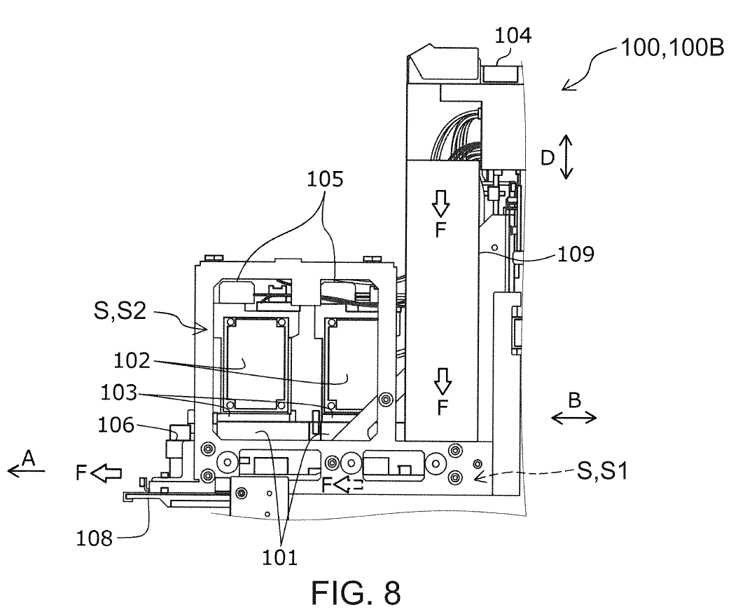

Next, a liquid ejection device in a second embodiment will be described with reference to FIGS. 7 and 8. In FIGS. 7 and 8, components that are common to those in the above first embodiment are indicated by the same symbols, and detailed explanations are omitted. Here, the liquid ejection device 1 in this embodiment has the same configuration as the liquid ejection device 1 in the first embodiment, except for a configuration of the carriage 100. Therefore, the liquid ejection device 1 in this embodiment can also be regarded as shown in FIG. 1, and except for the portions explained below, the liquid ejection device 1 in this embodiment has the same features as the liquid ejection device 1 in the first embodiment.

As shown in FIG. 7 and FIG. 8, a carriage 100B of the liquid ejection device 1 in this embodiment has a duct 109 that serves as a passage for air that flows by the carriage fans 104 into the internal space S from the space outside the carriage 100B. The duct 109 is an air passage extending from the position of the carriage fans 104 in the second space S2 to the first space S1, in which the heads 101 is provided.

As shown in FIGS. 7 and 8, a discharge fan 110 is provided in the first space S1 as a second fan that sends air from the internal space S of the carriage 100B toward the space outside the carriage 100B. In FIGS. 7 and 8, the air flow in the internal space S of the carriage 100B of air that flowed, by the carriage fans 104, into the internal space S from the space outside the carriage 100B, to be discharged toward the space outside by the discharge fan 110, is indicated by arrows F.

As described above, in the carriage 100B of the liquid ejection device 1 in this embodiment, the discharge fan 110 as the second fan is provided in the first space S1. Therefore, by causing air in the first space S1 to flow out before the air in the first space S1 stagnates there and accumulates heat, the liquid ejection device 1 in this embodiment can suppress temperature rise of the first space S1 and temperature rise of the heads 101.

### Third Embodiment

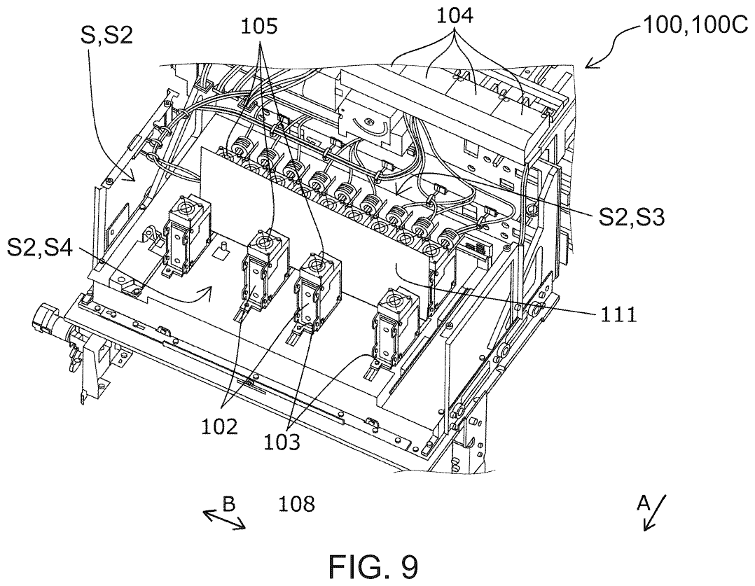

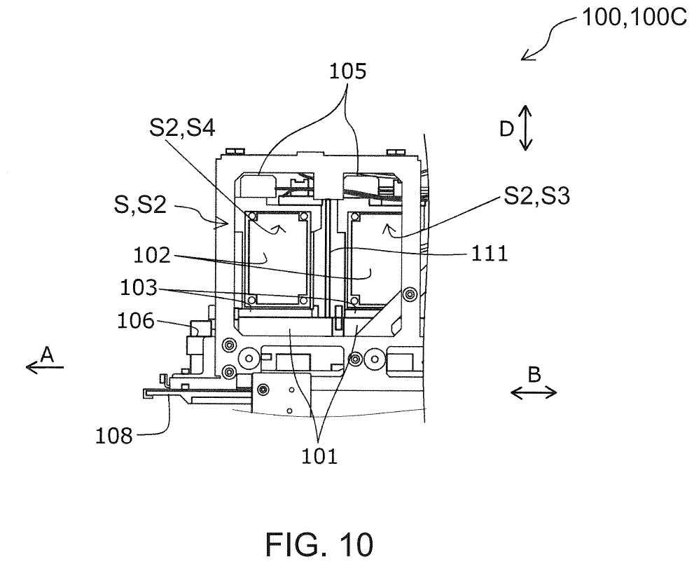

Next, a liquid ejection device in a third embodiment will be described with reference to FIGS. 9 and 10. In FIGS. 9 and 10, components that are common to those in the above first and second embodiments are indicated by the same symbols, and detailed explanations are omitted. Here, the liquid ejection device 1 in this embodiment has the same configuration as the liquid ejection device 1 in the first and second embodiments, except for the configuration of the carriage 100. Therefore, the liquid ejection device 1 in this embodiment can also be regarded as shown in FIG. 1, and except for the portions explained below, the liquid ejection device 1 in this embodiment has the same features as the liquid ejection device 1 in the first and second embodiments.

As shown in FIG. 9 and FIG. 10, in a carriage 100C of the liquid ejection device 1 in this embodiment, in addition to the partition plate 106 that partitions the internal space S of the carriage 100 into a first space S1 and a second space S2, there is a polyethylene partition plate 111 that further partitions the second space S2. Specifically, the partition plate 111 separates the plurality of control substrates 102 in the second space S2 into upstream side control substrates 102 in the transport direction A and downstream side control substrates 102 in the transport direction A. Here, as shown in FIGS. 9 and 10, for example, a region where the upstream side control substrates 102 in the transport direction A among the plurality of control substrates 102 are provided can be regarded as a third space S3, and a region where the downstream side control substrates 102 in the transport direction A among the plurality of control substrates 102 is provided can be regarded as a fourth space S4. Note that the carriage 100C in this embodiment has the same configuration as the carriage 100A of the liquid ejection device 1 in the first embodiment, except that the partition plate 111 is provided.

### Fourth Embodiment

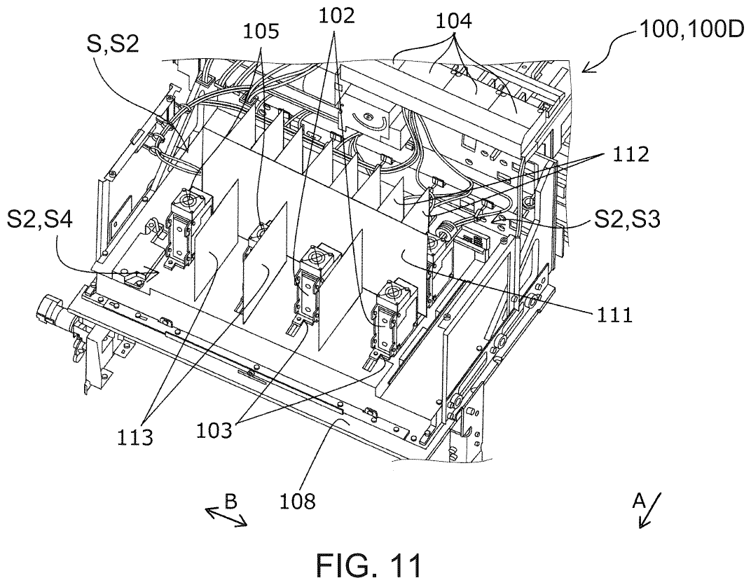

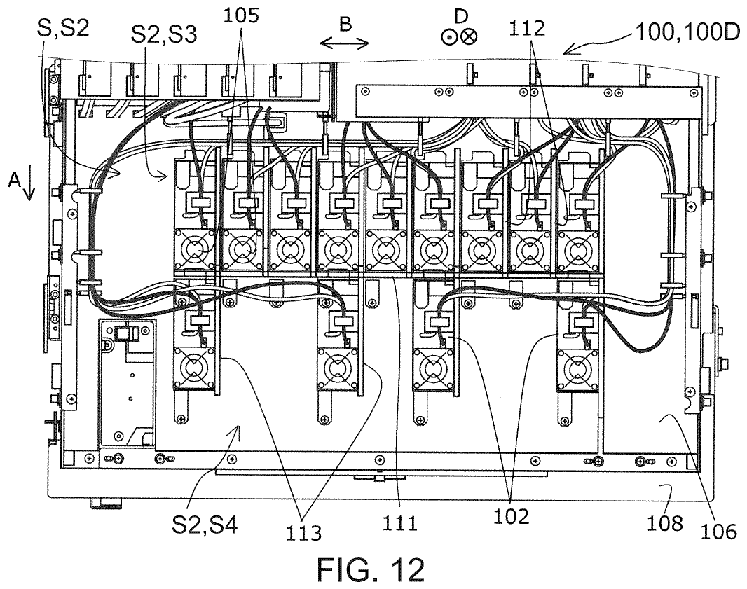

Next, a liquid ejection device 1 in a fourth embodiment will be described with reference to FIG. 11 and FIG. 12. In FIGS. 11 and 12, components that are common to those in the above first through third embodiments are indicated by the same symbols, and detailed explanations are omitted. Here, the liquid ejection device 1 in this embodiment has the same configuration as the liquid ejection device 1 in the first through third embodiments, except for the configuration of the carriage 100. Therefore, the liquid ejection device 1 in this embodiment can also be regarded as shown in FIG. 1, and except for the portions explained below, the liquid ejection device 1 in this embodiment has the same features as the liquid ejection device 1 in the first through third embodiments.

As shown in FIGS. 11 and 12, a carriage 100D of the liquid ejection device 1 in this embodiment has a plurality of partition plates 112 and a plurality of partition plates 113, made of polyethylene, that further partition the second space S2 in the carriage 100C of the liquid ejection device 1 in the third embodiment. Specifically, the partition plates 112 separate the upstream side control substrates 102 in transport direction A among the plurality of control substrates 102 in the second space S2 into individual spaces. The partition plates 113 separate the downstream side control substrates 102 in the transport direction A among the plurality of control substrates 102 in the second space S2 into individual spaces. Here, as shown in FIGS. 11 and 12, for example, a region where any one of the control substrates 102 among the control substrates 102 is provided can be considered as the third space S3, and a region where another one the control substrate 102 among the plurality of control substrates 102 is provided can be considered as the fourth space S4. Note that the carriage 100D in this embodiment has the same configuration as the carriage 100C of the liquid ejection device 1 in the third embodiment, except that the partition plates 112 and the partition plates 113 are provided in addition to the partition plate 106 and the partition plate 111.

Similar to the carriage 100A of the liquid ejection device 1 in the first embodiment, the carriage 100C of the liquid ejection device 1 in the third embodiment and the carriage 100D of the liquid ejection device 1 in the fourth embodiment also have a plurality of heads 101 and a plurality of control substrates 102 that correspond to respective heads 101. The second space S2 can be regarded as being partitioned into the third space S3 in which a first control substrate (for example, the upstream side control substrate 102 in the transport direction A) as the control substrate 102 is connected to a first ejection head (for example, the upstream side head 101 in the transport direction A) among the heads 101 is provided and the fourth space S4 in which a second control substrate (for example, the downstream side control substrate 102 in the transport direction A) as the control substrate 102 is connected to a second ejection head (for example, the downstream side head 101 in the transport direction A) among the head 101 is provided. With this configuration, the heat generated in the first control substrate can be suppressed from reaching the fourth space S4 and the heat generated in the second control substrate can be suppressed from reaching the third space S3.

Here, there is no particular limitation on how to partition the second space S2 into the third space S3 and the fourth space S4. The second space S2 may be partitioned into the third spaces S3 and the fourth spaces S4 for each control substrates 102 as shown in the carriage 100C of the liquid ejection device 1 in the third embodiment, or the second space S2 may be partitioned into the third spaces S3 and the fourth spaces S4 for each control substrates 102 as shown in the carriage 100D of the liquid ejection device 1 in the fourth embodiment.

Note that the present disclosure is not limited to the above described embodiments, and various modifications can be made within the scope of the disclosure described in the claims, and it goes without saying that they are also included in the scope of the present disclosure.

What is claimed is:

1. A liquid ejection device comprising:
a carriage whose internal space is partitioned into a first space and a second space by a partition plate;
an ejection head that is provided in the first space and that ejects liquid; and
a control substrate that is provided in the second space and that controls drive of the ejection head, wherein
the control substrate is connected to the ejection head via a substrate-to-substrate connector and
the partition plate, as viewed from a direction in which the control substrate is connected to the ejection head, is shaped such that at least any one region of a region where the control substrate is located, a region where the substrate-to-substrate connector is located, and a region where the ejection head is located, is cut out.

2. The liquid ejection device according to claim 1, wherein
the partition plate is non metallic.

3. The liquid ejection device according to claim 2, wherein
the partition plate is resinous.

4. The liquid ejection device according to claim 1, wherein
the carriage has a fan that generates airflow.

5. The liquid ejection device according to claim 4, wherein
the liquid ejection device has, as the fan, a first fan that draws air from a space outside the carriage into the internal space.

6. The liquid ejection device according to claim 5, wherein
the first fan is provided in the second space.

7. The liquid ejection device according to claim 4, wherein
the liquid ejection device has, as the fan, a second fan that exhausts air from the internal space to a space outside the carriage.

8. The liquid ejection device according to claim 7, wherein
the second fan is provided in the second space.

9. The liquid ejection device according to claim 7, wherein
the second fan is provided in the first space.

10. The liquid ejection device according to claim 1, wherein
the liquid ejection device has a plurality of the ejection heads and has a plurality of the control substrates corresponding to each of the ejection heads.

11. The liquid ejection device according to claim 10, wherein
the second space is partitioned into a third space and a fourth space, and in the third space, a first control substrate as the control substrate, which is connected to a first ejection head among the ejection heads, is provided, and in the fourth space, a second control substrate as the control substrate, which is connected to a second ejection head among the ejection heads, is provided.
